(19) United States
(12) Patent Application Publication
(10) Pub. No.: US 2005/0143882 A1
(43) Pub. Date: Jun. 30, 2005

(54) Maintenance service supporting terminal, maintenance service supporting method, maintenance service supporting program, and OBD history data

(76) Inventor: Hiroyuki Umezawa, Tokyo (JP)

Correspondence Address: ANDERSON KILL & OLICK, P.C., 1251 Avenue of the Americas, New York, NY, 10020, US

(21) Appl. No.: 10/934,860

(22) Filed: Sep. 3, 2004

(30) Foreign Application Priority Data
Sep. 4, 2003 (JP) 2003-312345

(51) Int. Cl. G06F 7/00

(52) U.S. Cl. 701/29

(57) ABSTRACT

A maintenance service supporting terminal for supporting a maintenance service for a vehicle by using an OBD code is disclosed. The maintenance service supporting terminal includes: an OBD code obtaining unit for obtaining the OBD code from the vehicle, a vehicle diagnosing unit for diagnosing the vehicle according to the obtained OBD code, and an estimating unit for estimating a fee for repairing the vehicle according to the diagnosis of the vehicle diagnosing unit.

### BACKGROUND OF THE INVENTION

1. Field of the Invention

The present invention generally relates to a maintenance service supporting terminal, a maintenance service supporting method, a maintenance service supporting program, and OBD (On-Board Diagnostic) history data for supporting maintenance using OBD codes.

2. Description of the Related Art

Recent automobiles engines are mostly electronically controlled by an ECU (Engine Control Unit). Accordingly, in a case of repairing an automobile with a malfunction, an auto-repair shop employs a scanning tool or the like for obtaining malfunction data by using the ECU and referring to the data in diagnosing the malfunctioned automobile.

The data obtained from the ECU is different depending on the automobile manufacturer. However, in recent years, an exhaust gas regulation, which is referred to as OBD (On-Board Diagnostic)-II, is employed internationally (centrally in the U.S.A.) for standardizing, for example, diagnosis connectors, diagnosis codes, and communication procedures (protocols).

In order to prevent a defective engine from releasing harmful exhaust gas and polluting the atmosphere, the OBD-II mandates that the ECU be equipped with a function of monitoring emission system of the engine.

Accordingly, automobile manufacturers in the U.S.A cannot sell automobiles unless the automobiles function in compliance to the standards of OBD-II.

By using the code data of the OBD-II standards (hereinafter referred to as OBD-II code) an automobile for any automobile manufacturer can be diagnosed with a same standard.

However, in Japan, since maintenance of an automobile is mainly performed by an automobile manufacturer corresponding to the automobile, the OBD code, serving as a uniform standard applicable to automobiles of different manufacturers, cannot be used effectively.

This is also a problem for common auto-repair shops, in which the auto-repair shops are required to be equipped with scanning tools corresponding to each of the various automobile manufacturers. Although there are generic scanning tools that correspond to the various automobile manufacturers, such scanning tools are expensive and are not commonly used. In addition, continuing to update code information in correspondence with the various automobile manufacturers is a burden for the auto-repair shops, and may lead to an increase in cost.

Accordingly, one conventional example proposes an OBD code(s) of a prescribed vehicle to be transmitted to an auto-repair shop for allowing the shop to estimate the cost for maintenance and send the estimated results to the owner of the prescribed vehicle. The example, however, does not disclose an OBD tool (unit) that actually issues an estimate sheet required for maintenance.

### SUMMARY OF THE INVENTION

It is a general object of the present invention to provide a maintenance service supporting terminal, a maintenance service supporting method, a maintenance service supporting program, and OBD history data that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a maintenance service supporting terminal, a maintenance service supporting method, a maintenance service supporting program, and OBD history data particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a maintenance service supporting terminal for supporting a maintenance service for a vehicle by using an OBD code, the maintenance service supporting terminal including: an OBD code obtaining unit for obtaining the OBD code from the vehicle; a vehicle diagnosing unit for diagnosing the vehicle according to the obtained OBD code; and an estimating unit for estimating a fee for repairing the vehicle according to the diagnosis of the vehicle diagnosing unit.

In the maintenance service supporting terminal according to an embodiment of the present invention, the maintenance service supporting terminal may further include a procedure/component information storing unit for storing at least one of procedure information and component information in connection with the OBD code.

In the maintenance service supporting terminal according to an embodiment of the present invention, the maintenance service supporting terminal may further include a procedure fee information storing unit for storing procedure fee information in connection with the procedure information.

In the maintenance service supporting terminal according to an embodiment of the present invention, the estimating unit may obtain corresponding procedure information corresponding to the obtained OBD code from the procedure/component information storing unit, and corresponding procedure fee information corresponding to the obtained corresponding procedure information from the procedure fee information storing unit.

In the maintenance service supporting terminal according to an embodiment of the present invention, the maintenance service supporting terminal may further include a component fee information storing unit for storing component fee information in connection with the component information.

In the maintenance service supporting terminal according to an embodiment of the present invention, the estimating unit may obtain corresponding component information corresponding to the obtained OBD code from the procedure/component information storing unit, and corresponding component fee information corresponding to the obtained corresponding component information from the component fee information storing unit.

In the maintenance service supporting terminal according to an embodiment of the present invention, the estimating unit may print out an estimate sheet indicative of the fee for repairing the vehicle.

In the maintenance service supporting terminal according to an embodiment of the present invention, the maintenance service supporting terminal may further include a diagnosis information generating unit for generating diagnosis information of the vehicle based on the obtained OBD code.

In the maintenance service supporting terminal according to an embodiment of the present invention, the maintenance service supporting terminal may further include a comment information storing unit for storing comment information in connection with the OBD code, wherein the comment information includes a diagnosis content corresponding to the OBD code for use as the diagnosis information.

In the maintenance service supporting terminal according to an embodiment of the present invention, the comment information storing unit may further include image information corresponding to the OBD code.

In the maintenance service supporting terminal according to an embodiment of the present invention, the diagnosis information generating unit may obtain corresponding comment information corresponding to the obtained OBD code from the comment information storing unit.

In the maintenance service supporting terminal according to an embodiment of the present invention, the diagnosis information generating unit may print out a diagnosis sheet indicative of generated diagnosis information.

In the maintenance service supporting terminal according to an embodiment of the present invention, the maintenance service supporting terminal may further include an OBD history information generating unit for generating OBD history information in connection with the obtained OBD code and vehicle identification information for identifying the vehicle.

In the maintenance service supporting terminal according to an embodiment of the present invention, the OBD history information may include at least one of mileage information, output date of the OBD code, engine speed information, engine load information, coolant temperature information, and speed information with respect to the vehicle.

In the maintenance service supporting terminal according to an embodiment of the present invention, the OBD history information may be transmitted to another terminal connected to the maintenance service supporting terminal.

Furthermore, the present invention provides a maintenance service supporting system including: a maintenance service supporting terminal including an OBD code obtaining unit for obtaining an OBD code from a vehicle, a vehicle diagnosing unit for diagnosing the vehicle according to the obtained OBD code, an estimating unit for estimating a fee for repairing the vehicle according to the diagnosis of the vehicle diagnosing unit, and an OBD history information generating unit for generating OBD history information in connection with the obtained OBD code and vehicle identification information for identifying the vehicle; and a management server including an OBD history information storing unit for storing OBD history information received from the maintenance service supporting terminal.

In the maintenance service supporting system according to an embodiment of the present invention, the management server may provide the OBD history information stored in the OBD history information storing unit to another terminal connected to the management server.

Furthermore, the present invention provides a maintenance service supporting method for supporting maintenance service for a vehicle by using an OBD code with a maintenance service supporting terminal, the method including the steps of: a) obtaining the OBD code from the vehicle; b) diagnosing the vehicle according to the obtained OBD code; and c) estimating a fee for repairing the vehicle according to the diagnosis of step b).

In the maintenance service supporting method according to an embodiment of the present invention, a database storing at least one of procedure fee information and component fee information in connection with the OBD code may be used in estimating the fee in step c).

In the maintenance service supporting terminal according to an embodiment of the present invention, an estimate sheet may be printed out after estimating the fee for repairing the vehicle in step c).

In the maintenance service supporting method according to an embodiment of the present invention, further including a step of d) generating diagnosis information of the vehicle based on the obtained OBD code.

In the maintenance service supporting method according to an embodiment of the present invention, a database storing comment information indicative of a diagnosis content corresponding to the OBD code in connection with the OBD code may be used in obtaining a comment used as the diagnosis information.

In the maintenance service supporting method according to an embodiment of the present invention, a diagnosis sheet may be printed out after the diagnosis information is generated in step d).

In the maintenance service supporting method according to an embodiment of the present invention, further including a step of e) generating OBD history information in connection with the obtained OBD code and vehicle identification information for identifying the vehicle.

In the maintenance service supporting method according to an embodiment of the present invention, the OBD history information may include at least one of mileage information, output date of the OBD code, engine speed information, engine load information, coolant temperature information, and speed information with respect to the vehicle.

In the maintenance service supporting terminal according to an embodiment of the present invention, the OBD history information may be transmitted to another terminal connected to the maintenance service supporting terminal.

Furthermore, the present invention provides a maintenance service supporting program for enabling a computer to support maintenance service for a vehicle by using an OBD code, the program including: a) an obtaining function for obtaining the OBD code from the vehicle; b) a diagnosing function for diagnosing the vehicle according to the obtained OBD code; and c) an estimating function for estimating a fee for repairing the vehicle according to the diagnosis of the diagnosing function.

Furthermore, the present invention provides an OBD history data including: vehicle identification information for identifying a vehicle; OBD code for being output from the vehicle; and running status information for showing a running status of the vehicle at a point when the OBD code is output.

In the OBD history data according to an embodiment of the present invention, the running status information may include at least one of mileage information, output date of the OBD code, engine speed information, engine load information, coolant temperature information, and speed information with respect to the vehicle.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary entire configuration of the present invention;

FIG. 2 is a schematic diagram showing an exemplary hardware configuration of a terminal and a server according to an embodiment of the present invention;

FIG. 3 is a block diagram showing software of a maintenance service supporting terminal according to an embodiment of the present invention;

FIG. 4 is a schematic diagram showing a customer vehicle database according to an embodiment of the present invention;

FIG. 5 is a schematic diagram showing a customer database according to an embodiment of the present invention;

FIG. 6 is a schematic diagram showing a vehicle database according to an embodiment of the present invention;

FIG. 7 is a schematic diagram showing an OBD code database according to an embodiment of the present invention;

FIG. 8 is a schematic diagram showing an OBD history database according to an embodiment of the present invention;

FIG. 9 is a schematic diagram showing a procedure/component database according to an embodiment of the present invention;

FIG. 10 is a schematic diagram showing a procedure (repair procedure) database according to an embodiment of the present invention;

FIG. 11 is a schematic diagram showing component database according to an embodiment of the present invention;

FIG. 12 is a schematic diagram showing a comment database according to an embodiment of the present invention;

FIG. 13 is a schematic diagram showing a history (replacement history) database according to an embodiment of the present invention;

FIG. 14 is a flowchart showing a process of a maintenance service supporting terminal (method) according to an embodiment of the present invention;

FIG. 15 is a schematic diagram showing a customer information registration screen according to an embodiment of the present invention;

FIG. 16 is a schematic diagram showing a vehicle information registration screen according to an embodiment of the present invention;

FIG. 17 is a schematic diagram showing an estimate sheet according to an embodiment of the present invention;

FIG. 18 is a schematic diagram showing a car diagnosis sheet (automobile diagnosis sheet) according to an embodiment of the present invention;

FIG. 19 is a schematic diagram showing a record input screen of a PDA according to an embodiment of the present invention;

FIG. 20 is a schematic diagram showing a record according to an embodiment of the present invention;

FIG. 21 is a flowchart showing a process of printing out an estimate sheet according to an embodiment of the present invention; and

FIG. 22 is a flowchart showing a process of printing out a diagnosis sheet according to an embodiment of the present invention.

### DESCRIPTION OF THE PREFERRED EMBODIMENTS

In the following, embodiments of the present invention will be described with reference to the accompanying drawings.

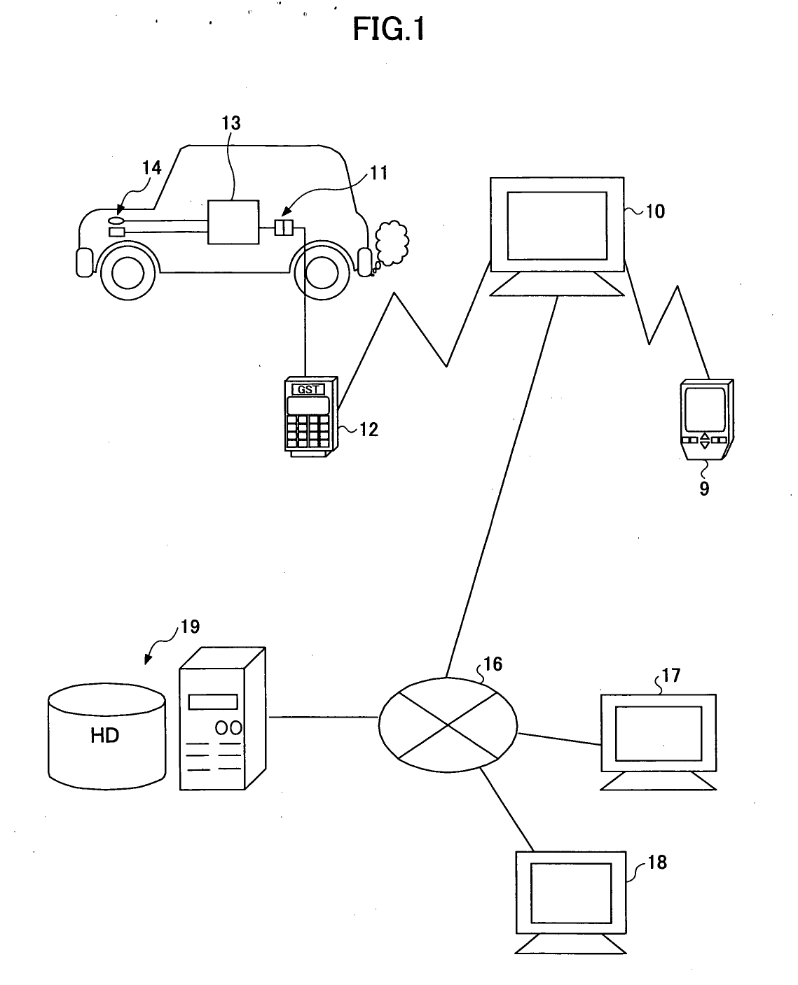

FIG. 1 is a schematic entire view of an apparatus according to an embodiment of the present invention. FIG. 1 shows a maintenance service support terminal 10, an exhaust gas reduction component 14, an ECU 13, a GST (Generic Scan Tool) 12, a diagnosis tool connector 12, a network 16, an automobile manufacturer terminal 17, a component manufacturer terminal 18, a mechanic PDA 9, and a management server 19.

The maintenance service support terminal 10 is a terminal provided to, for example, an auto-repair shop, or an automobile dealer. The maintenance service support terminal 10 is connected to the GST 12 via, for example, a wireless LAN, or a blue tooth unit. The maintenance service support terminal 10 receives an OBD code from the GST 12, and also exchanges record information with the mechanic PDA (Personal Digital Assistant) 9. Furthermore, the maintenance service support terminal 10 is connected to the network 16.

The GST 12 is a malfunction diagnosing tool, which identifies the location of the malfunction and/or determines the state of the malfunction. The mechanic PDA 9 is a PDA for allowing record information in a record to be input by a mechanic (technician). The mechanic PDA 9 receives OBD code and returns record information in accordance with the OBD code.

The exhaust gas reduction component 14 and the ECU 13 are provided to a vehicle (automobile). The ECU 13 is a unit serving to control an engine, in which the ECU 13 controls the engine in accordance with signals received from sensors of, for example, the exhaust gas reduction component 14.

The automobile manufacturer terminal 17 and the component manufacturer terminal 18 are terminals provided to an automobile manufacturer and a component manufacturer, respectively. An analysis tool program (described below) is installed in the automobile manufacturer terminal 17 and the component manufacturer terminal 18. The management server 19 serves to store and manage, for example, OBD history information, that is, history information of OBD code obtained from the maintenance service support terminal 10. The management server 19 provides the OBD history information to the automobile manufacturer terminal 17 and the component manufacturer terminal 18.

The maintenance service support terminal 10 and the management server 19 correspond to a maintenance service support system. The automobile manufacturer terminal 17 and the component manufacturer terminal 18 correspond to other terminals.

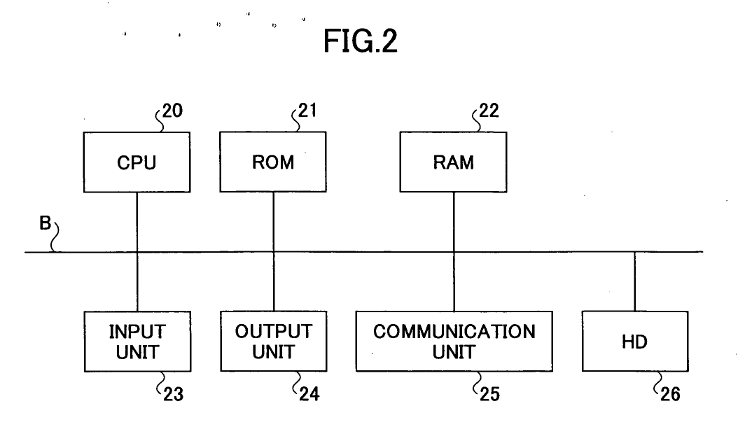

Next, a schematic hardware composition of the maintenance service support terminal 10, the automobile manufacturer terminal 17, the component manufacturer terminal 18, and the management server 19 is described with reference to FIG. 2. Such terminals and server have a composition relatively the same as that of a typical personal computer or a workstation. As shown in FIG. 2, a CPU (Central Processing Unit) 20, a ROM 21, a RAM 22, an input unit 23, an output unit 24, a communication unit 25, a HD 26, and a bus B for connecting the units are provided thereto.

The CPU 20 performs execution of various programs and computation processes. The ROM 21 stores, for example, programs required in activation (start-up). The RAM 22 temporarily stores processes of the CPU 20, and data. The input unit 23 is, for example, a keyboard, and/or a mouse. The output unit 24 is, for example, a display, and/or a printer. The communication unit 25 performs communication between the network 16 and the GST 12. The HD 26 stores various data and programs.

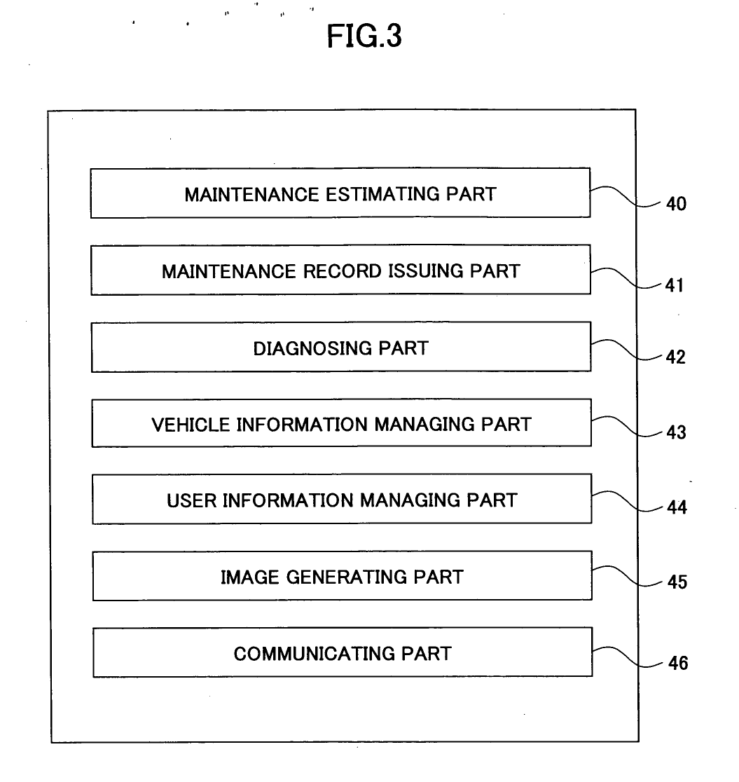

Next, the software of the maintenance service support terminal 10 is described with reference to the block diagram shown in FIG. 3. The maintenance service support terminal 10 includes a maintenance estimating part 40 corresponding to an estimating unit, a maintenance register issuing part 41, a diagnosing part 42 corresponding to a automobile analyzing unit and OBD history information generating unit, an automobile information managing part 43, a user information managing part 44, an image generating part 45, and a communicating part 46 corresponding to an OBD code obtaining unit.

The maintenance estimating part 40 reads procedure/component exchange master 4 from the HD 26 and searches for a repair procedure and/or a component corresponding to an OBD code. The maintenance estimating part 40 stores search results to the RAM 22, requests printing format data of an estimate from the HD 26, and prints out the estimate from the output unit 24.

The maintenance register issuing part 41 requests a printing format data of the register, and prints out the register from the output unit 24. The diagnosing part 42 reads OBD codes and determines whether repair is necessary.

The automobile information managing part 43 collects obtained automobile model information and stores the information in an automobile information database. The user information managing part 44 manages customer information. The image generating part 45 generates an image to be displayed on the maintenance service support terminal 10.

The communicating part 36 provides functions applicable to a driver for communicating with, for example, the GST 12 via a network, and/or to various protocols. For example, the communicating part 36 has functions corresponding to, for example, TCP/IP (Transmission Control Protocol/Internet Protocol), and/or HTTP (Hyper Text Transfer Protocol), and serves to provide overall communication functions.

Next, a database for updating and referring with the foregoing software is described. It is to be noted that the same data may be included in different data bases. In such a case, the description of data being already described in another data will be omitted.

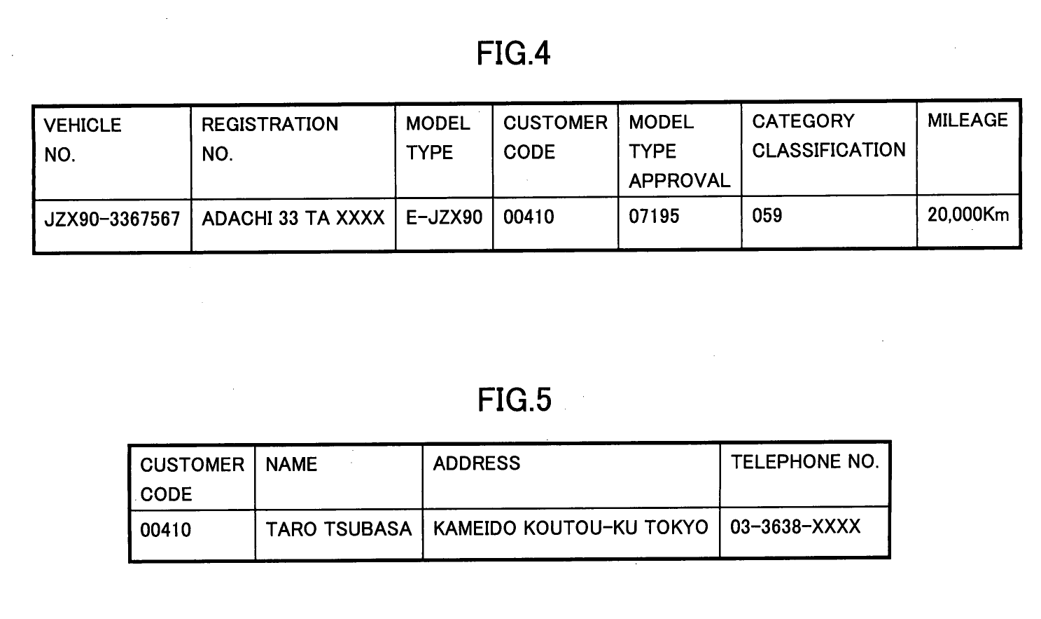

FIG. 4 shows a customer automobile database for managing automobiles of customers. The customer automobile database includes automobile number, registration number, model type, customer code, model type designation, classification, and travel distance.

The automobile number, the registration number, the model type, the model type designation, and the classification are automobile information indicated in an automobile safety inspection certificate. The customer code is a number uniquely given to each customer. The travel distance is the total distance that an automobile has traveled.

With reference to the table shown in FIG. 4, it is shown that the user with a customer code of 00410 has an automobile with an automobile number of JZX90-3367567, a registration number of Adachi 33 Ta XXXX, a model type of E-JZX90, a model type designation of 07195, a classification of 059, and a travel distance of 20,000 km.

Next, a customer database for managing customers is described with reference to FIG. 5. The database shown in FIG. 5 includes customer codes, names, addresses, and telephone numbers. The name, address, and telephone number shown in the table are those of the user.

In FIG. 5, Mr. Taro Tsubasa with a customer code of 00410 has an address of ◯ chome ◯ banchi Kouto-ku Tokyo, and a telephone number of 03-3638-xxxx.

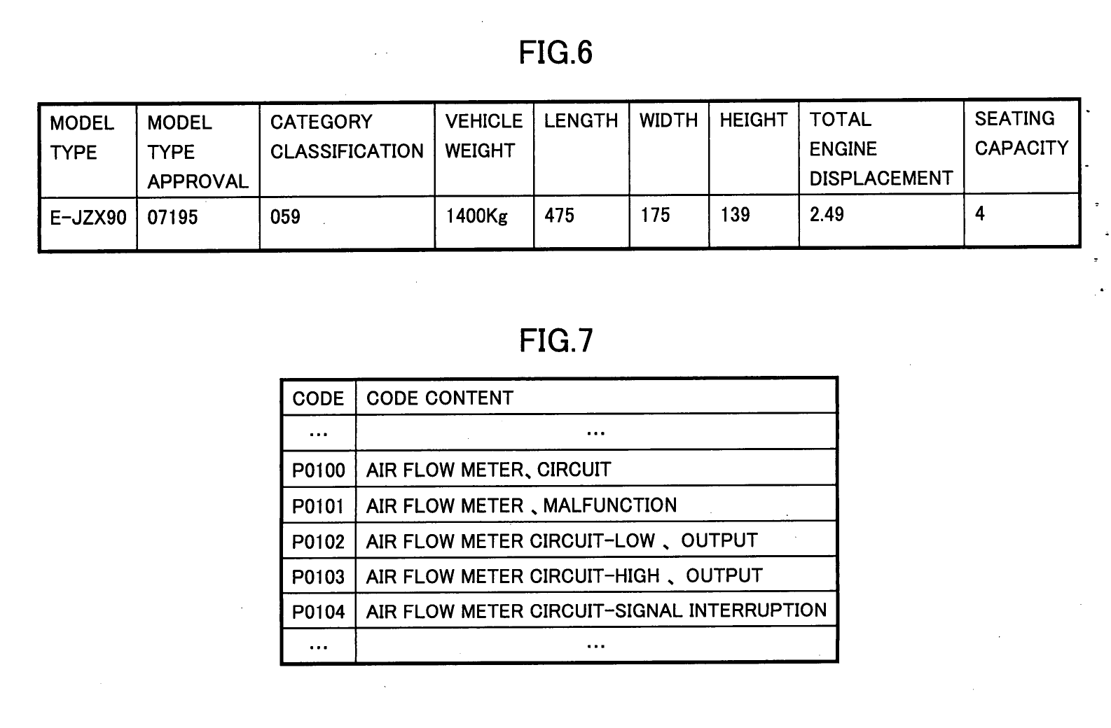

Next, an automobile database for managing data of most automobiles distributed in the market is described with reference to FIG. 6.

The automobile database shown in FIG. 6 includes “model type”, “model type designation”, “classification”, “automobile weight”, “length”, “width”, “height”, “total engine displacement”, and “seating capacity”, in which “automobile weight” indicates the weight of the automobile, “length” indicates the length of the automobile, “width” indicates the width of the automobile, “height” indicates the height of the automobile, “total engine displacement” indicates the engine displacement of the automobile, and the “seating capacity” indicates the capacity of passengers of the automobile.

In FIG. 6, the automobile of model type E-JZX 90 has a model type designation of 07195, a classification of 059, an automobile weight of 1400 kg, a length of 475 cm, a width of 175 cm, a height of 139 cm, a total engine displacement of 2.49 liters, and a passenger capacity of 4 people.

Next, an OBD code database is described with reference to FIG. 7. Since the OBD code database includes several hundred codes, FIG. 7 shows the OBD code database in an abbreviated manner.

The OBD code database is a database including “OBD code” and “code matter” corresponding to the “OBD code”. Here, the OBD code shown in FIG. 7 is an OBD code of an air flow meter for directly measuring air absorption quantity. For example, “P0104” is an OBD code indicating disconnection of signals from a circuit of an air flow meter.

Accordingly, since OBD code and code matter corresponding to the OBD code are included in the database, the state of an automobile is determined when a code is received from the GST 12.

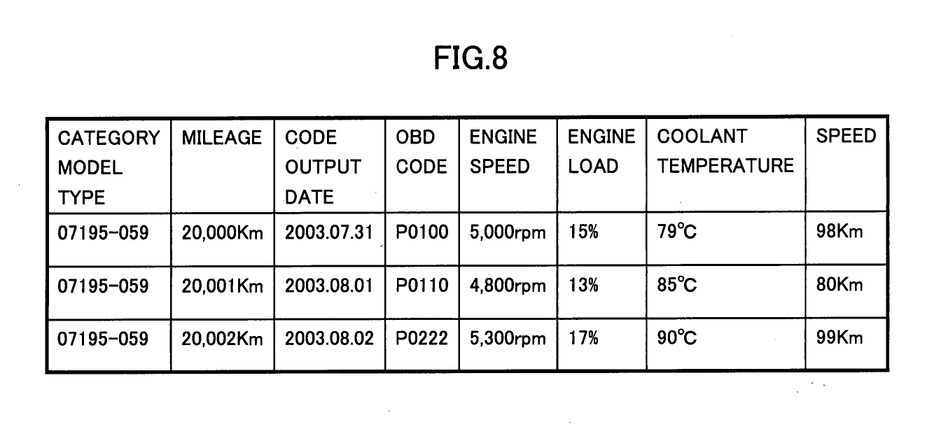

Next, an OBD history database, which is managed in the management server 19, is described with reference to FIG. 8, in which the OBD history database is indicated in relation with OBD code, and automobile identification information for identifying automobiles. The OBD history database corresponding to OBD history information includes “model type category”, “travel distance”, “code output date”, “OBD code”, “engine speed”, “engine load”, “coolant temperature”, and “speed”.

The “model type category” corresponds to automobile identification information, and is indicated by matching the above-described model type designation and category class. As an alternative of the “model type category”, codes indicating model types, automobile manufacturer names, or automobile type may be used. The “travel distance” is the traveled distance of the automobile obtained when the OBD code is output. The “code output date” is the date when the OBD code is output. The “engine speed”, “engine load”, “coolant temperature”, and “speed” are those obtained when the OBD code is output, respectively.

The data in the OBD history database is temporarily stored in the ECU when the OBD code is output. When the automobile is delivered to an auto-repair shop, the stored data is transferred to the maintenance service support terminal via the GST.

For example, as shown in FIG. 8, according to the output on Aug. 1, 2003, the automobile with a model type class 07195-059 has an engine speed of 4,800 rpm, an engine load of 13%, a coolant temperature of 85° C., a speed of 80 km, and an OBD code of P0100.

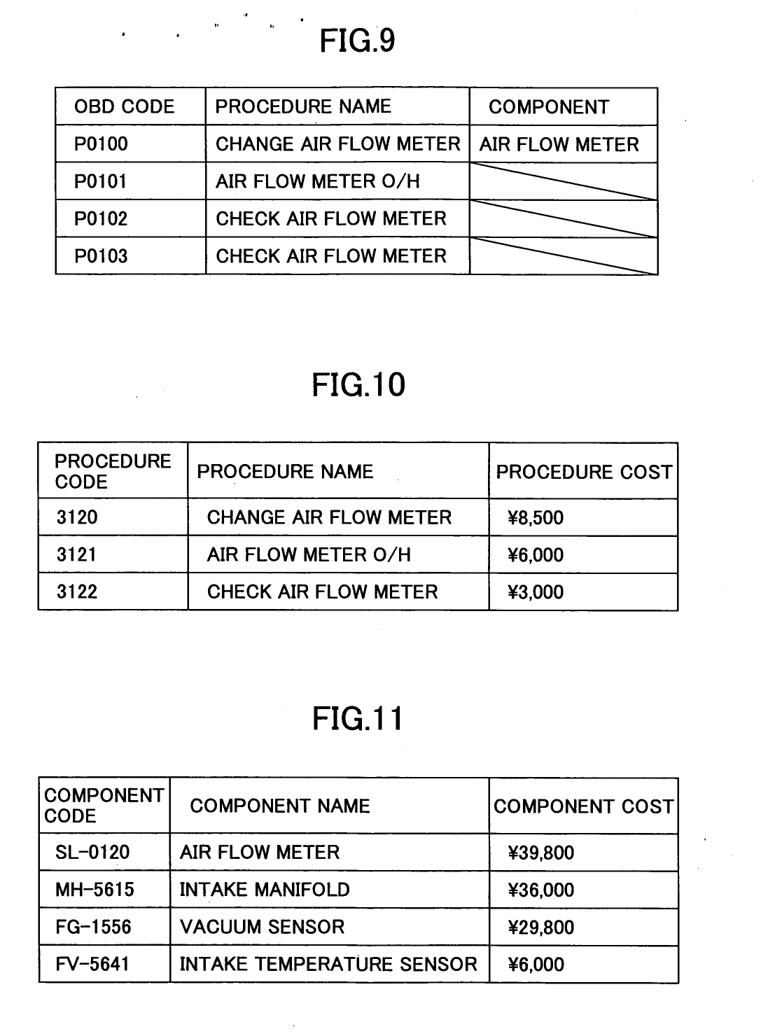

Next, a repair procedure/component database storing repair procedure and component in connection with OBD code is described with reference to FIG. 9. The repair procedure/component data base, which corresponds to a procedure/component information storing unit, includes data of “OBD code”, “repair procedure name”, and “component name”. The “component name” refers to a name of a component required for executing a repair procedure. It is to be noted that the “component name” is crossed out with a diagonal line when no component is required.

For example, as shown in FIG. 9, in a case where the OBD code is P0100, the repair procedure name is indicated as “change air flow meter”, and the component name is indicated as “air flow meter”. In a case where the OBD code is P0102, the repair procedure name is indicated as “check air flow meter”, and the component name is indicated with a diagonal line since the check requires no component.

Next, a repair procedure database (procedure database) storing repair procedures in connection with repair procedure fees is described with reference to FIG. 10. The repair procedure database, corresponding to a procedure fee information storing unit, includes “repair procedure code”, “repair procedure (repair procedure name)”, and “repair procedure fee”. The “repair procedure code” is a code distributed to each of the repair procedures. The “repair procedure fee” is a fee that arises from performing a repair procedure. Although the repair procedure fee is indicated, for the sake of convenience, in units of yen, the data of the repair procedure fee is actually indicated with use of “standard repair procedure point(s)”. For example, the data is indicated with a numeral of 0.6, in which the repair procedure fee is the product of standard repair procedure point and a repair procedure rate for one hour. The repair procedure rate is left to the discretion of the auto-repair shop.

For example, as shown in FIG. 10, an air flow meter inspection (procedure code 3122) is indicated with a repair procedure fee of 3,000 yen.

Next, a component database storing component information in connection with component fees, is described with reference to FIG. 11. The component database, corresponding to a component fee information storing unit, includes “component code”, “component (component name)”, and “component fee”. The “component code” is a code distributed to each of the components. The “component fee” is a fee of a component.

For example, as shown in FIG. 11, an air flow meter (component code SL-0120) is indicated with a component fee of 39,800 yen.

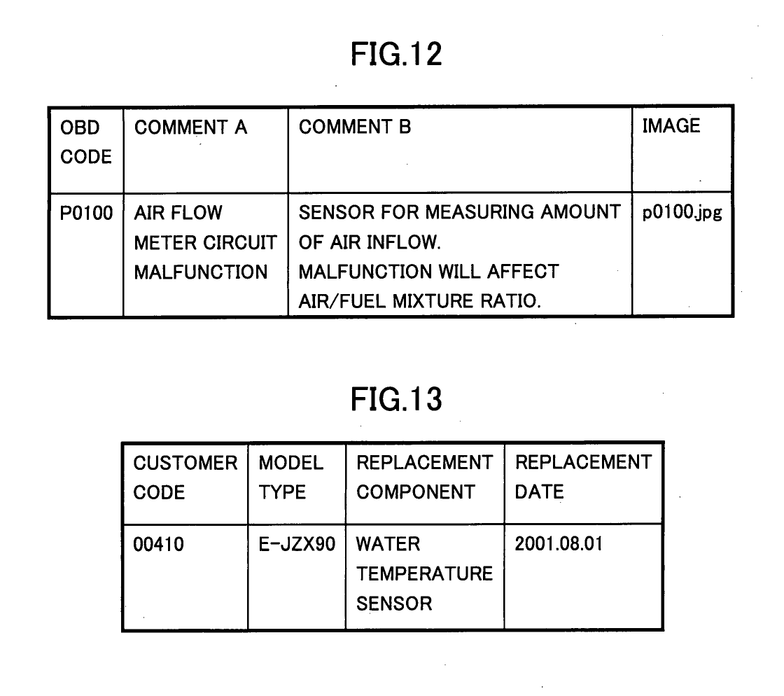

Next, a comment database, being used for diagnosis information and storing diagnosis content corresponding to OBD code, is described with reference to FIG. 12. The comment database, corresponding to a comment information storing unit, includes data for “OBD code”, “Comment A”, “Comment B”, and “Image”.

The “Comment A” and “Comment B” are comments that are indicated on a diagnosis sheet. The “Image” is an image indicated on the diagnosis sheet, and serves as image information for showing the malfunction location corresponding to the OBD code.

For example, as shown in FIG. 12, Comment A corresponding to OBD code P0100 indicates malfunction of the air flow meter circuit, and Comment B indicates what kind of damage the malfunction may cause.

Next, a replacement history database (history database) indicating a history of component(s) replaced for the customer's vehicle is described with reference to FIG. 13. The replacement history database includes data for “customer code”, “model type”, “replacement component”, and “replacement date”.

The “replacement component” indicates a component that was replaced in the past. The “replacement date” indicates the date when a component was replaced. For example, FIG. 13 shows that the vehicle (model type E-JZX90) of the customer (customer code 00410) had its water temperature sensor replaced on Aug. 1, 2001.

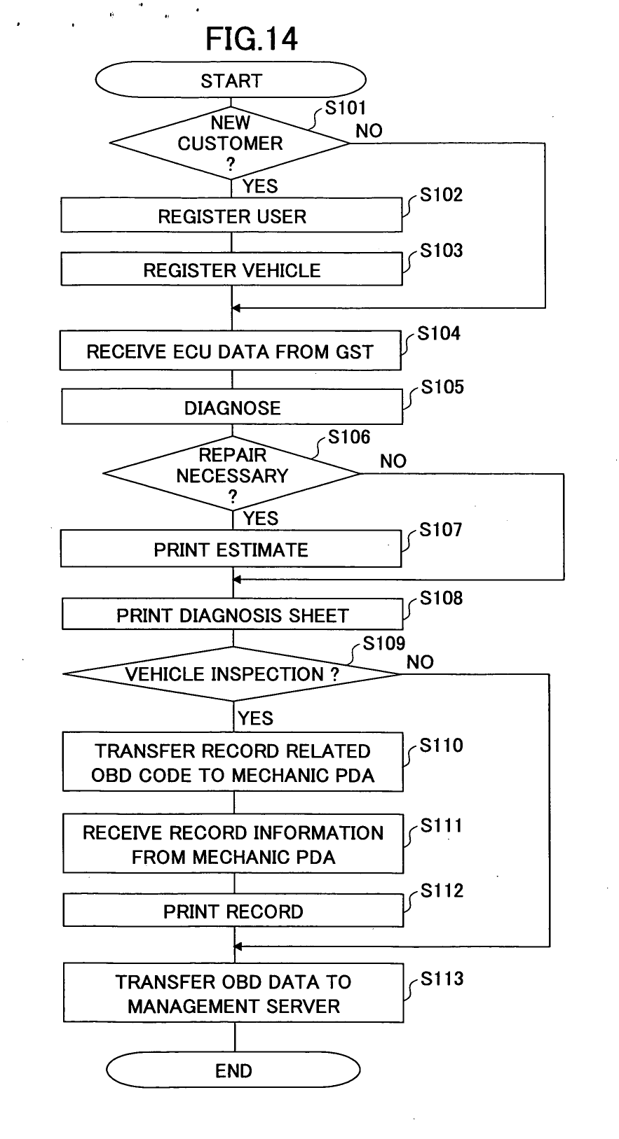

Next, an actual process according to an embodiment of the present invention is described with reference to a flowchart shown in FIG. 14. This flowchart shows a process of the maintenance service supporting terminal 10, including operations, such as, recording of customer information, obtaining OBD codes, and transferring OBD history information to the management server.

In Step S101, a user information management part 44 determines whether the customer is a new customer. In this determining process, an operator may, for example, input the name and telephone number of the customer, to thereby allow the user information managing part 44 to search the customer database. If there is no hit in the search, the user information managing part 44 determines that the customer is a new customer. In an alternative example, the determination process may be performed by using a card with a customer code recorded thereto (for example, the customer code being recorded magnetically or in a bar code), in which the customer is determined as a new customer when the operator inputs that the customer has no card.

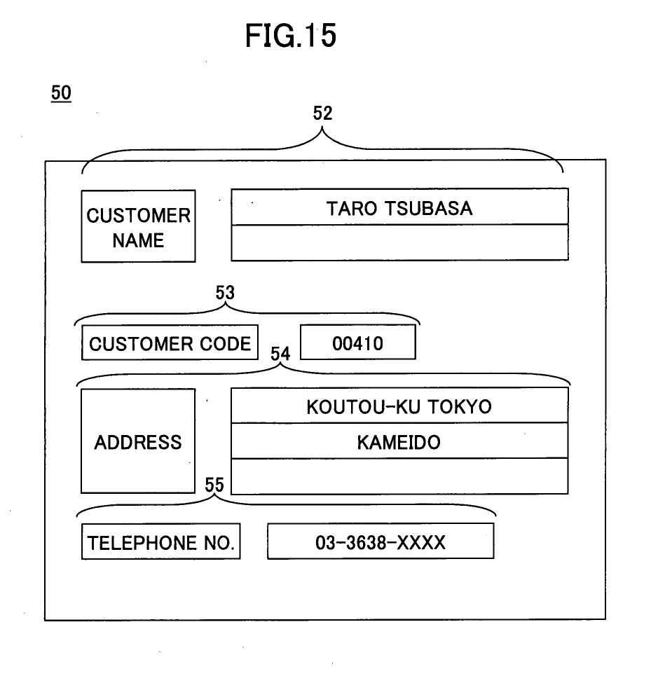

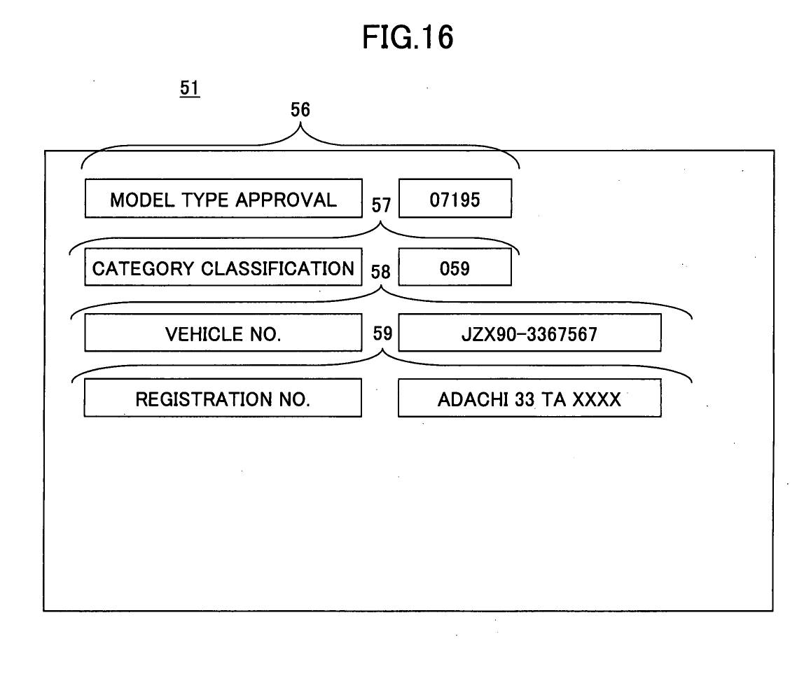

In Step S102, when the customer is determined to be a new customer (YES in Step S101), the user information managing part 44 uses the image generating part 45 to display the screens 50, 51 shown in FIGS. 15 and 16. The screen 50 shown in FIG. 15 is a screen used in registering customer information. The screen 50 displays, for example, a customer name input space 52, a customer code space 53, an address input space 54, and a telephone number input space 55.

The customer name input space 52 is a space for an operator to input a customer name. The customer code space 53 is a space that displays a customer code automatically set according to a system. The telephone number input space 55 is a space for an operator to input a telephone number.

The screen 51 shown in FIG. 16 is a screen used in registering vehicle information. The screen 51 displays, for example, a model type approval input space, a category classification input space 57, a vehicle number input space 58, and a registration number input space 59. The operator inputs information corresponding to the input spaces in the screen 51 of FIG. 16. It is unnecessary to manually input all of the various information of a target inspection vehicle since the information can be extracted from the vehicle database by inputting, for example, model type approval, category classification, or model type.

Then, in Step S104 (corresponding to an OBD code obtaining step), the diagnosing part 42 receives ECU 13 data from the GST 20, which is connected to the ECU 13 with a diagnosis tool connector 11. Here, the received data is an OBD code. In Step S105 (corresponding to a vehicle diagnosis step, a diagnosis information generation step, and an OBD history information generation step), the diagnosing part 42 performs diagnosis when receiving the OBD code. In Step S106, the diagnosing part 42 determines whether repair is necessary.

Basically, it is determined that some kind of repair procedure (e.g. component replacement, overhaul) is necessary when the OBD code received. However, there are some cases where a data error is output. Whether it is an error may be determined, for example, depending whether the OBD code is consecutively output or whether the OBD is temporarily output. Even if the error is temporary, an inspecting person may, just in case, inspect performance or the like according to his/her judgment. Alternatively, the OBD codes may be ranked in order so that the maintenance service support terminal can determine repair according to the rank of the OBD code. Alternatively, the maintenance service support terminal may determine that repair is necessary simply when an OBD code is received. It is to be noted that the term “repair” includes, for example, inspection, maintenance, component replacement, and/or component attachment.

In the Step S105, OBD history information is generated when repair is determined necessary.

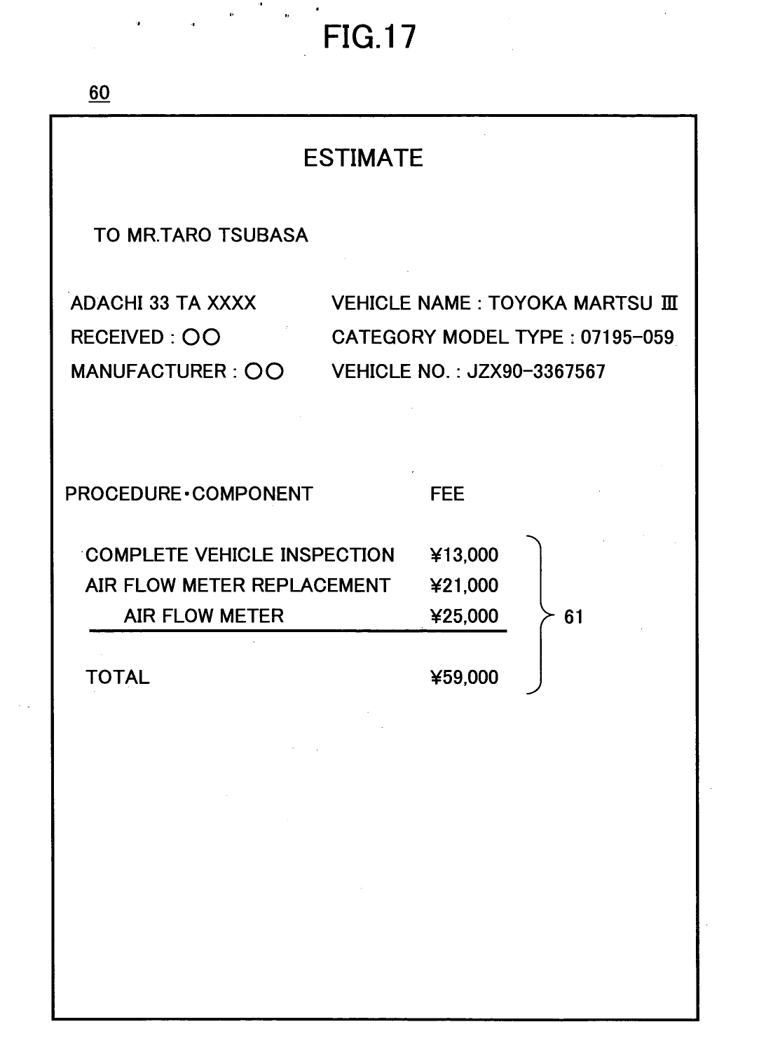

If it is determined in the diagnosis that no repair is necessary (NO in Step S106), the process advances to Step S108. If it is determined that repair is necessary (YES in Step S106), the processes advances to Step S107. In the Step S107, the maintenance estimating part 40 prints out an estimate 60. An example of the estimate 60 is shown in FIG. 17. The estimate 60 of FIG. 17 shows necessary fees in a space 61 indicative of repair procedure/component name and its fees.

In the estimate 60 shown in FIG. 17, since a complete vehicle inspection is performed in addition to replacing the air flow meter, the space 61 in the estimate 60 indicates a complete vehicle inspection fee of 13000 yen, an air flow meter replacement fee of 21000 yen, an air flow meter component fee of 25000 yen, and a total fee of 59000 yen.

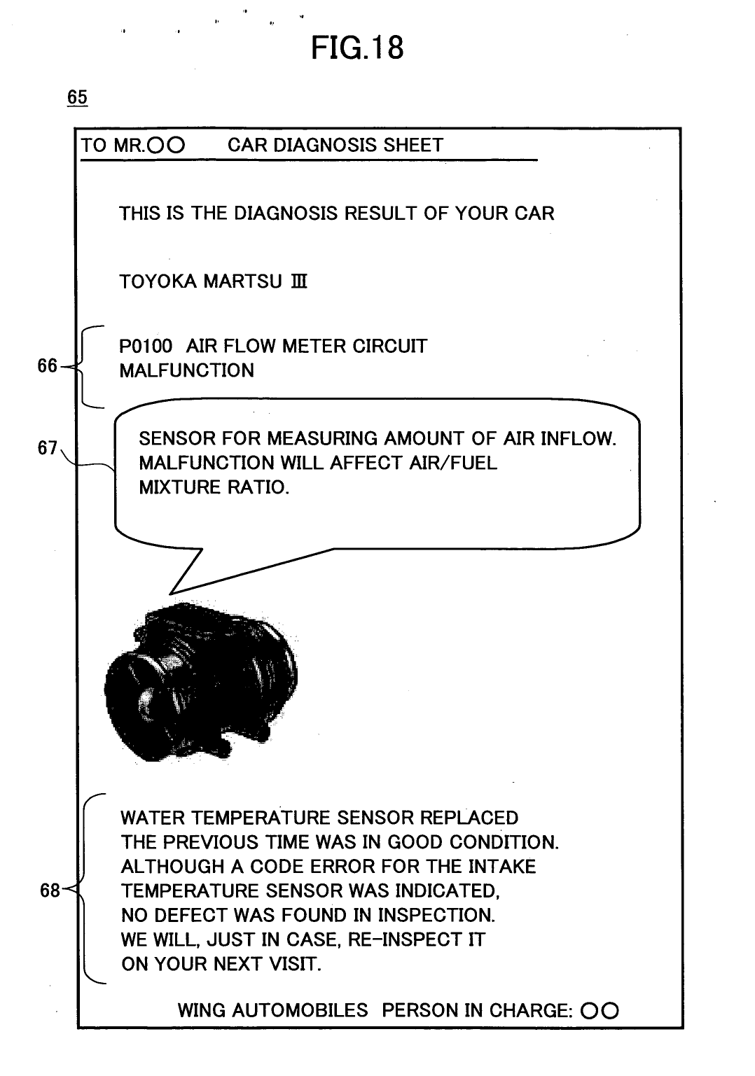

Accordingly, when it is determined that repair is necessary, the above-described estimate 60 is printed. In the same manner, a diagnosis sheet 65 is printed in Step S108. An example of the diagnosis sheet 65 is shown in FIG. 18. The diagnosis sheet 65 includes a malfunction information space 66, an explanation space 67, and a history information space 68.

The malfunction information space 66 indicates an OBD code (in FIG. 18, OBD code P0100), and information corresponding to the OBD code (in FIG. 18, air flow meter circuit malfunction).

The explanation space 67 shows what kind of problem would occur when there is such malfunction. The explanation space 67 in FIG. 18 explains that the air flow meter is a sensor for measuring the amount of air inflow, and that malfunction thereof will affect air/fuel mixture ratio.

The history information space 68 shows the current state of a component that was replaced the previous time (if any). Furthermore, the history information space 68 shows an inspection result for this time, and also information for next time. The history information space 68 shows that “The water temperature sensor replaced the previous time was in good condition. Although a code error for the intake temperature sensor was indicated, no defect was found in the inspection. We will, just in case, re-inspect it on your next visit.”

Next, in Step S109, it is decided whether to conduct vehicle inspection. This decision may be executed, for example, by allowing an operator to input whether to perform vehicle inspection via a display on a screen. The process proceeds to Step S113 if it is decided not to conduct the vehicle inspection (NO in Step S109).

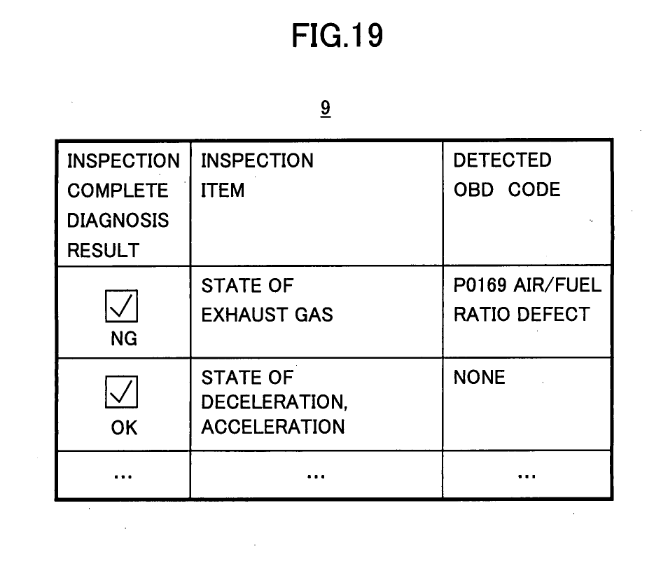

If it is decided to conduct the vehicle inspection (YES in Step S109), an OBD code related to the register is transmitted to the mechanic PDA. Accordingly, items to be input to the register, and code information corresponding to OBD codes are displayed in the mechanic PDA 9, as shown in FIG. 19.

FIG. 19 shows check-boxes for marking inspection items and spaces for inputting OK or NG as the results. For example, the state of exhaust gas, which is one of the inspection items in the register, is shown in correspondence with the OBD code P0169 detected in the inspection, and its code information (here, air/fuel ratio defect).

A mechanic inputs register information to the mechanic PDA 9 by referring to the displayed information, and transmits the register information to the maintenance service support terminal 10.

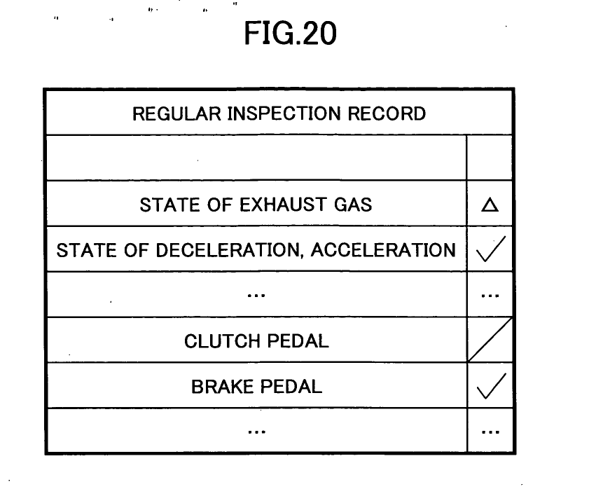

After the maintenance service support terminal 10 receives the register information in Step S111, the register shown in FIG. 20 is printed (Step S112). The register shown in FIG. 20 is simplified by indicating the items shown in FIG. 20 and omitting other remaining items. The state of the exhaust gas corresponding to the detected OBD code is shown with a triangle mark for indicating “repair”.

Then, the maintenance service support terminal 10 transfers the OBD code to the management server (Step S113), thereby completing the process.

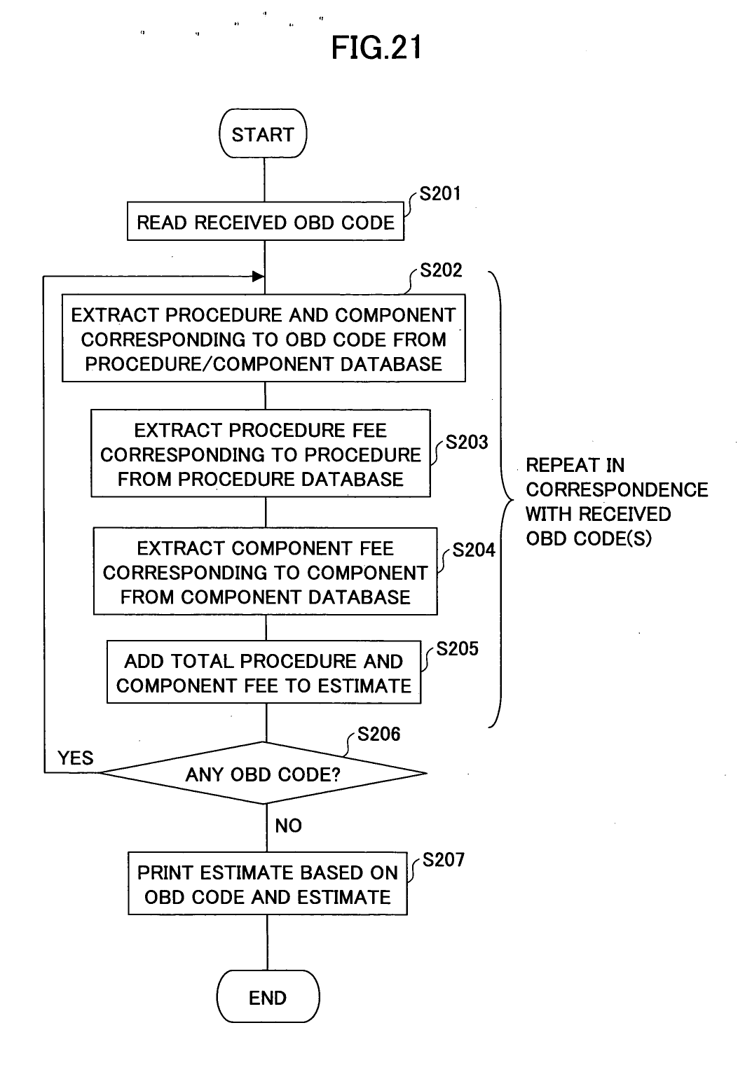

Next, the operation of obtaining (and printing) an estimate (see Step S107 in FIG. 14) is described in more detail with reference to a flowchart of FIG. 21.

In Step S201, the maintenance estimating part 40 reads a received OBD code. In Step S202, the maintenance estimating part 40 extracts a repair procedure and component corresponding to the OBD code from the procedure/component database.

In Step S203, the maintenance estimating part 40 extracts a repair procedure fee corresponding to the repair procedure from the repair procedure database. In Step S204, the maintenance estimating part 40 extracts a component fee corresponding to an extracted component from the component database. In Step S205, the maintenance estimating part 40 adds the total of the repair procedure fee and the component fee extracted in the Steps S203 and S204 to the estimate.

The steps of S202 to S205 are repeated in correspondence with the number of received OBD code(s). In Step S206, the maintenance estimating part 40 determines whether there is any unprocessed OBD codes remaining. The Step S201 is executed if there is an unprocessed OBD code. In Step S207, the maintenance estimating part 40 prints out an estimate based on the OBD code(s) and the computed estimate.

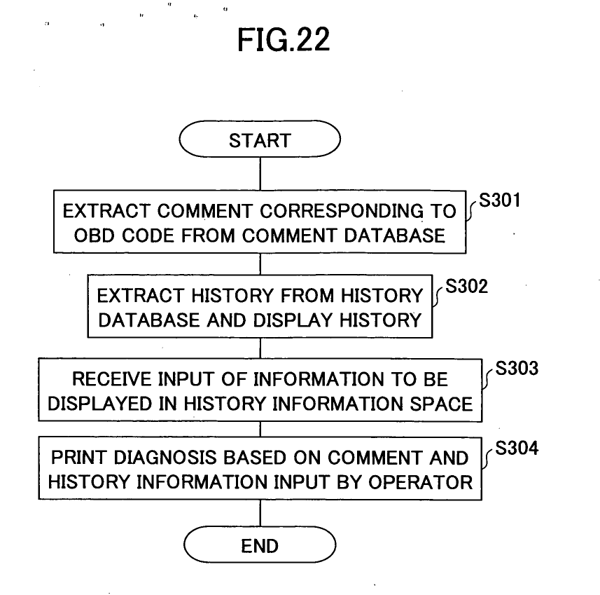

Next, the operation of printing a diagnosis sheet (see Step S108 in FIG. 14) is described in more detail with reference to a flowchart of FIG. 22. In Step S301 (corresponding to a diagnosis information generation step), the diagnosing part 42 extracts a comment corresponding to an OBD code from a comment database. The extracted comment is used for the malfunction information space 66 and the explanation space 67 (see FIG. 18).

In Step S302, the diagnosing part 42 extracts history from a history database, and displays the extracted history to the operator. In Step S303, the diagnosing part 42 receives input of the information to be displayed in the history information space 68 from the operator. As an alternative of the input of the operator, a fixed format may be prepared beforehand to allow information read out from the history database to be inserted into the fixed format.

In Step S304, the diagnosing part 42 prints the comment and input information from the operator to the diagnosis sheet, thereby completing the process.

In consequence, according to the above-described embodiment of the present invention, regardless of manufacturer, a suitable repair procedure and/or component can be obtained, and applied to an estimate or an electronic register or the like. Furthermore, a static(s) of proportion defective for each vehicle type or component can be obtained by using an analyzing tool, to thereby serve to improve vehicle safety.

Furthermore, since the management server 19 continuously stores history (lifelong history) of a vehicle, engine related components can be diagnosed in accordance with the history. Furthermore, the management server 19 is able to store vehicle data of various automobile manufacturers by connecting to respective automobile repair (e.g. maintenance, sheet metal) factories via a network.

The vehicle data of the various automobile manufacturers has information of various vehicles uniformly expressed with OBD codes, and is based on the vehicles that are actually used. This information can be of valuable data for automobile manufacturers and automobile component manufacturers. For example, although an automobile manufacturer may be able to obtain data information of its own automobiles from its affiliated automobile dealers or the like, it is difficult for the automobile manufacturer to obtain such information of other automobile manufacturers.

Furthermore, performance comparison with rival manufacturers can be performed by applying the OBD codes stored in the management server 19 to a commercially available analyzing tool (e.g. “Dr. Sum” by Tsubasa System Co. Ltd.).

Furthermore, property analysis of vehicles can be performed, for example, analyzing failure rate of an automobile of a same type of a same manufacturer used in different regions. Furthermore, since the data is obtained from actually used automobiles, the data is more useful analysis data compared to data obtained merely from, for example, inspections of an automobile plant and test-drives on a circuit. Furthermore, a more efficient analysis can be performed by further obtaining data, such as, engine speed, engine load, coolant temperature, and/or speed of the vehicle.

Further, the present invention is not limited to these embodiments, but various variations and modifications may be made without departing from the scope of the present invention.

The present application is based on Japanese Priority Application No. 2003-312345 filed on Sep. 4, 2003, with the Japanese Patent Office, the entire contents of which are hereby incorporated by reference.

1. A maintenance service supporting terminal for supporting a maintenance service for a vehicle by using an OBD code, the maintenance service supporting terminal comprising:
an OBD code obtaining unit for obtaining the OBD code from the vehicle;
a vehicle diagnosing unit for diagnosing the vehicle according to the obtained OBD code; and
an estimating unit for estimating a fee for repairing the vehicle according to the diagnosis of the vehicle diagnosing unit.

2. The maintenance service supporting terminal as claimed in claim 1, further comprising a procedure/component information storing unit for storing at least one of procedure information and component information in connection with the OBD code.

3. The maintenance service supporting terminal as claimed in claim 2, further comprising a procedure fee information storing unit for storing procedure fee information in connection with the procedure information.

4. The maintenance service supporting terminal as claimed in claim 3, wherein the estimating unit obtains corresponding procedure information corresponding to the obtained OBD code from the procedure/component information storing unit, and corresponding procedure fee information corresponding to the obtained corresponding procedure information from the procedure fee information storing unit.

5. The maintenance service supporting terminal as claimed in claim 2, further comprising a component fee information storing unit for storing component fee information in connection with the component information.

6. The maintenance service supporting terminal as claimed in claim 5, wherein the estimating unit obtains corresponding component information corresponding to the obtained OBD code from the procedure/component information storing unit, and corresponding component fee information corresponding to the obtained corresponding component information from the component fee information storing unit.

7. The maintenance service supporting terminal as claimed in claim 1, wherein the estimating unit prints out an estimate sheet indicative of the fee for repairing the vehicle.

8. The maintenance service supporting terminal as claimed in claim 1, further comprising a diagnosis information generating unit for generating diagnosis information of the vehicle based on the obtained OBD code.

9. The maintenance service supporting terminal as claimed in claim 8, further comprising a comment information storing unit for storing comment information in connection with the OBD code, wherein the comment information includes a diagnosis content corresponding to the OBD code for use as the diagnosis information.

10. The maintenance service supporting terminal as claimed in claim 9, wherein the comment information storing unit further includes image information corresponding to the OBD code.

11. The maintenance service supporting terminal as claimed in claim 9, wherein the diagnosis information generating unit obtains corresponding comment information corresponding to the obtained OBD code from the comment information storing unit.

12. The maintenance service supporting terminal as claimed in claim 8, wherein the diagnosis information generating unit prints out a diagnosis sheet indicative of generated diagnosis information.

13. The maintenance service supporting terminal as claimed in claim 1, further comprising an OBD history information generating unit for generating OBD history information in connection with the obtained OBD code and vehicle identification information for identifying the vehicle.

14. The maintenance service supporting terminal as claimed in claim 13, wherein the OBD history information includes at least one of mileage information, output date of the OBD code, engine speed information, engine load information, coolant temperature information, and speed information with respect to the vehicle.

15. The maintenance service supporting terminal as claimed in claim 14, wherein the OBD history information is transmitted to another terminal connected to the maintenance service supporting terminal.

16. A maintenance service supporting system comprising:
a maintenance service supporting terminal including an OBD code obtaining unit for obtaining an OBD code from a vehicle, a vehicle diagnosing unit for diagnosing the vehicle according to the obtained OBD code, an estimating unit for estimating a fee for repairing the vehicle according to the diagnosis of the vehicle diagnosing unit, and an OBD history information generating unit for generating OBD history information in connection with the obtained OBD code and vehicle identification information for identifying the vehicle; and
a management server including an OBD history information storing unit for storing OBD history information received from the maintenance service supporting terminal.

17. The maintenance service supporting system as claimed in 16, wherein the management server provides the OBD history information stored in the OBD history information storing unit to another terminal connected to the management server.

18. A maintenance service supporting method for supporting maintenance service for a vehicle by using an OBD code with a maintenance service supporting terminal, the method comprising the steps of:
a) obtaining the OBD code from the vehicle;
b) diagnosing the vehicle according to the obtained OBD code; and
c) estimating a fee for repairing the vehicle according to the diagnosis of step b).

19. The maintenance service supporting method as claimed in claim 18, wherein a database storing at least one of procedure fee information and component fee information in connection with the OBD code is used in estimating the fee in step c).

20. The maintenance service supporting method as claimed in claim 18, wherein an estimate sheet is printed out after estimating the fee for repairing the vehicle in step c).

21. The maintenance service supporting method as claimed in claim 18, further comprising a step of
d) generating diagnosis information of the vehicle based on the obtained OBD code.

22. The maintenance service supporting method as claimed in claim 21, wherein a database storing comment information indicative of a diagnosis content corresponding to the OBD code in connection with the OBD code is used in obtaining a comment used as the diagnosis information.

23. The maintenance service supporting method as claimed in claim 21, wherein a diagnosis sheet is printed out after the diagnosis information is generated in step d).

24. The maintenance service supporting method as claimed in claim 18, further comprising a step of
e) generating OBD history information in connection with the obtained OBD code and vehicle identification information for identifying the vehicle.

25. The maintenance service supporting method as claimed in claim 24, wherein the OBD history information includes at least one of mileage information, output date of the OBD code, engine speed information, engine load information, coolant temperature information, and speed information with respect to the vehicle.

26. The maintenance service supporting method as claimed in claim 24, wherein the OBD history information is transmitted to another terminal connected to the maintenance service supporting terminal.

27. A maintenance service supporting program for enabling a computer to support maintenance service for a vehicle by using an OBD code, the program comprising:
a) an obtaining function for obtaining the OBD code from the vehicle;
b) a diagnosing function for diagnosing the vehicle according to the obtained OBD code; and
c) an estimating function for estimating a fee for repairing the vehicle according to the diagnosis of the diagnosing function.

28. An OBD history data comprising:
vehicle identification information for identifying a vehicle;
OBD code for being output from the vehicle; and
running status information for showing a running status of the vehicle at a point when the OBD code is output.

29. The OBD history data as claimed in claim 28, wherein the running status information includes at least one of mileage information, output date of the OBD code, engine speed information, engine load information, coolant temperature information, and speed information with respect to the vehicle.
